(19) United States
(12) Patent Application Publication
(10) Pub. No.: US 2003/0120734 A1
(43) Pub. Date: Jun. 26, 2003

(54) Method and system for peer-to-peer networking and information sharing architecture

(76) Inventors: Justin Kagan, Sherman Oaks, CA (US); Ming Shieh, Covina, CA (US)

Correspondence Address: Deborah S. Gladstein, Morrison & Foerster LLP, 2000 Pennsylvania Ave., N.W., Washington, DC, 20006-1888, US

(21) Appl. No.: 10/172,491

(22) Filed: Jun. 17, 2002

Related U.S. Application Data
(60) Provisional application No. 60/298,117, filed on Jun. 15, 2001.

(51) Int. Cl. G06F 15/16; G06F 17/30

(52) U.S. Cl. 709/206; 707/3; 709/229

(57) ABSTRACT

A system for retrieving remote data based on its content is provided where a plurality of content servers is provided in which each content server has a database which stores data and a corresponding searchable real-time index of the data stored in the database. A search client issues a query for data to a relay server, which is connected to the plurality of content servers. Each of the plurality of content servers search their respective indices for data corresponding to the query and, if data corresponding to the query is stored in the respective database, a message is sent through the relay server to the search client.

### BACKGROUND OF THE INVENTION

1. Field of the Invention

The present invention relates to peer to peer networking and information sharing.

2. Description of the Related Art

The recent past has seen an explosion in the number of computer users with access to higher-bandwidth Internet connections. With this increase in available bandwidth comes an increase in the amount of information that people are becoming accustomed to working with. The ability to effectively manage and make sense of the mass of knowledge a modern computer user is exposed to becomes more urgent as the Internet continues to grow.

One product, called Enfish Onespace, assists in this task. This is an engine utilizing Enfish's Dexing technology. This mature technology, first made available in the product Enfish Tracker Pro, creates a thorough and up-to-the-minute cross-referenced index of all the meaningful content on a person's computer, including every word in most popular file types, e-mails, Internet favorites/bookmarks, and personal information management applications (PIMs) such as Microsoft Outlook. Enfish Onespace uses the dexing technology to rapidly search for any combination of words and/or data types, producing a list of the relevant information everywhere on that computer instantly.

While file-swapping utilities such as Napster and Gnutella have recently come into existence, most, if not all products are limited by the scope of the information they were capable of searching for and sharing, typically relying on text contained in the names of files to determine the relevance of any given item. Conventionally, references to available content are maintained in a massive centralized repository, necessitating the need for costly back-end database servers to perform searches on behalf of users looking for information. Web search engines work this way.

Many fine applications already exist to enable real-time collaboration over a network, such as Lotus Notes and Groove. Additionally, there are many tools available today for simple swapping of files of varying formats. While each of these individually performs some utilitarian task, none can claim to be all things to all people.

### SUMMARY OF THE INVENTION

The present invention overcomes the drawbacks and disadvantages of existing methods and systems and provides a series of advantages that will become evident upon reading of the present specification.

The present invention is capable of rapidly searching for and retrieving remote data based on its content. Indices built on any given set of machines may be searched in response to another user's query for information. The machines may respond with results referring to the relevant information they contain and have chosen to share. A central server, or a scalable cluster of central relay servers, may simply reflect a user's query toward any machines advertising a willingness to share a given set of information and each machine can share thousands of items without ever having to upload the entire content list to a central location to be indexed. Thereby, the work of actually performing the search may be broken up into small manageable tasks that are delegated in parallel to each machine, which searches only the scope of its own content. The location of any given shared item on a host computer is unimportant. Most notably, because each individual index may be updated continually, the results that are routed back to the originator of the query are almost guaranteed to contain purely live links, unlike those culled from conventional Internet search engines with higher indexing latency. The net result of this is the effective creation of a massively distributed, parallel searchable real-time index of content, regardless of its source or format.

Another object of the invention is to rapidly find and work with many different kinds of data seamlessly in one easy-to-use application, regardless of where that information resides or how it was created.

The present invention provides a method for sharing data. The invention supports a clean, streamlined interface that empowers a user to share any amount of data desired with a minimum of effort, but with the knowledge that private information that is not to be shared remains securely unavailable to others.

The present invention may also be capable of making the network boundary seamless for users seeking information beyond their own PC. Although network latency is unavoidable, the present invention may still feel responsive and snappy to the user. In order to accomplish this, search results may be relayed in the shortest time possible from any given peer. Results from peers responding more quickly may reach the recipient immediately without being delayed by slower peers suffering from bandwidth constraints. These earlier results may be instantly useable while other peers continue to respond with additional information, without the necessity to collate everything into a single list beforehand. The hardware limitations of any particular network node do not necessarily constitute a weak link.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

The above objective and advantages of the present invention will become more apparent by describing in detail a preferred embodiment thereof with reference to the attached drawings in which:

FIG. 1 illustrates a Private enterprise Internet relay server according to one embodiment of the invention;

FIG. 2 illustrates a public Internet Relay Server cluster according to one embodiment of the invention;

FIG. 3 illustrates a Generic Web Browsers Access according to one embodiment of the invention;

FIG. 4 illustrates data security according to one embodiment of the invention; and

FIG. 5 illustrates data security according to one embodiment of the invention.

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to the like elements throughout. The embodiments are described below in order to explain the present invention by referring to the figures.

In one embodiment of the invention, called selfish peer-to-peer networking, data may be shared across the multiple PCs, PDAs, and wireless devices of one user (home, laptop, and work) as a replacement for emailing or synchronizing information. By ensuring that personal information is always easily available regardless of when and where it is needed, expensive, time-consuming, and/or complicated sync platforms become unnecessary. Because people tend to be focused first on themselves, using peer-to-peer technology in this way helps to save time and effort, making work more seamless.

In another embodiment, data may be shared within a tight workgroup or closely inter-operating people, such as an executive and assistant, or a business development team. This eliminates the necessity to remember how and when to sync or copy important documents to a shared drive. In addition to saving time, this embodiment alleviates users from having to think about whether specific documents would be useful to others. During work in progress, the person responsible for the revision of a working document may host and share it so everyone else accesses it easily. Virtual teams reliant on the same documents or spreadsheets can share highly dynamic information with outside sources, either on the same network or over the Internet.

In yet another embodiment, the frequency of access for every piece of information may be tracked on a user's machine. This information may then be used to ascertain the relative importance of each item, helping to determine what information should be automatically copied to a shared server. Through this mechanism, new information (contacts, etc.) could be centrally acquired from a sales force or other team and archived without the need for users to remember to publish or share. This helps to solve one of the biggest problems for knowledge management in companies; namely, the task of keeping content/knowledge updated, fresh, and current. Additionally, it provides a way to integrate desktop content as part of an enterprise knowledge portal.

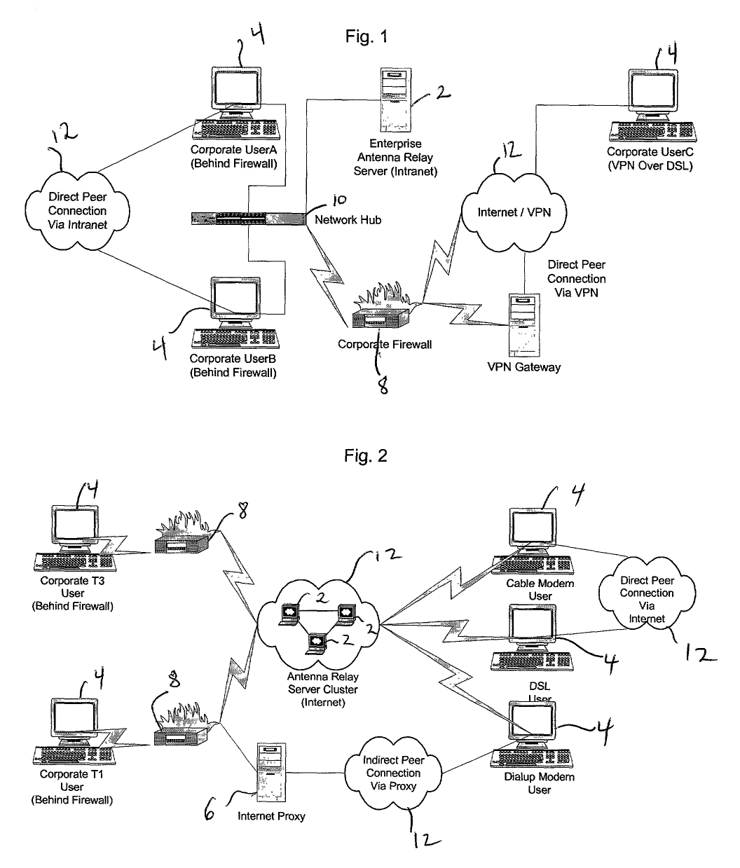

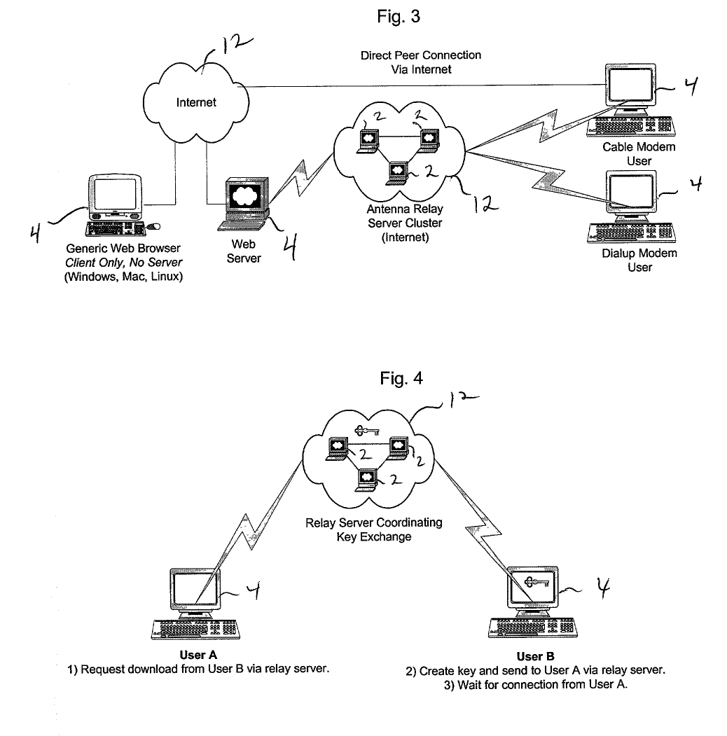

The system of the present invention is illustrated in FIG. 1. The present invention includes a relay server 2, which may be a Windows NT® installable service. In its simplest form, it is a commonly accessible reflector; a scalable conduit of messages between authenticated end-users wishing to exchange information of some sort, similar to those that relay instant messages. The relay server 2 itself does not transfer content, but rather allows each machine 4 to route small messages through the server 2 to other machines 4 for the purpose of locating remote information and negotiating its transfer directly between peers (or if necessary, through a mutually acceptable proxy 6, as shown in FIG. 2). The messages may adhere to a strictly defined proprietary, yet highly extensible format known as the Antenna Protocol, developed by Enfish to facilitate communication and data transfer between clients, including those behind a firewall 8.

Machines that provide an interface to the user for the purpose of querying other computers for published content are referred to as search clients. Machines that are willing to share information over the network are called content servers. While not strictly required, in most cases both functions are performed by a single piece of software known as a servent, named so because it acts as both a server and a client. Any such machine, when connected via a TCP stream and logged in to the relay server, has a pipeline capable of sending and receiving messages on the network 10. Since the connection with the relay server is outbound from inside any firewalls, there is an open bi-directional channel of communication between the two so long as both ends keep the connection alive. This makes it possible for two users behind separate firewalls to send messages to each other via the relay server 2.

As shown in FIG. 2, a plurality of scalable cluster of public relay servers 2 connected to the Internet 12 can be maintained, intended for use by the general public. By utilizing these servers, users can ensure that the information on any of their computers is available at any computer equipped with an Internet connection anywhere else in the world, so long as the machine 4 sharing the information maintains an open connection via the Internet. However, companies with concerns about data confidentiality may choose to purchase and install their own private relay servers. While still providing the identical functionality necessary for searching and sharing, a private relay server resides safely on a company's intranet behind a firewall. It provides additional security by restricting access and eliminating the need for clients to open an outbound connection over the Internet. Only users within the enterprise can connect to this private server, thereby limiting the availability of the information they share to the same set of users.

FIGS. 1 and 2 illustrate these two scenarios. The major advantage to this architecture is that it utilizes high-speed, high-bandwidth central servers 2 to relay messages, so users with slower network connections (modems) are incapable of creating network bottlenecks for users 4 with higher bandwidth connections (cable modem, DSL, T1, or T3). This was (and still is) one of the major flaws of some “pure” peer-to-peer networks (e.g., Gnutella), where queries for information may hop numerous times through connections of wildly varying bandwidth before reaching the intended recipients. In that architecture, the result is that any node in the chain with a high-latency connection slows everybody down, not just itself. The present invention does not have this inherent shortcoming, because the existence of a relay server 2 makes all queries hop the shortest possible path to all endpoints, in most cases no more than two or three times.

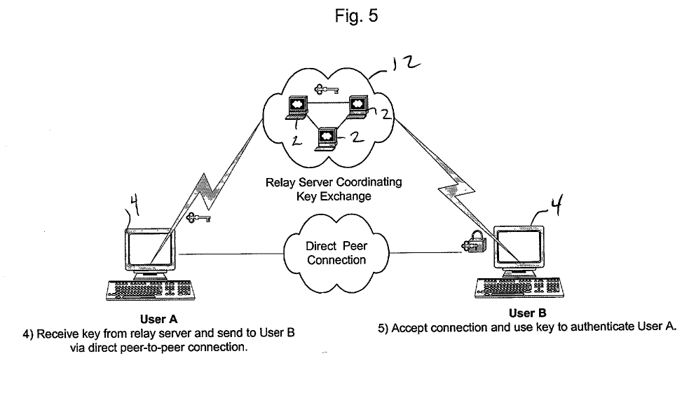

With the present invention, as illustrated in FIG. 5, content is shared and downloaded directly from peer machines over a peer-to-peer connection 3 using common HTTP, the protocol that powers the worldwide web and employed by every web browser. This enables future server-based web portals to be built which are capable of searching for information on behalf of a web-based client, providing users with machines that have little more than web browsers to download content, even if they are on non-Windows® platforms.

To guard against unauthorized downloading from a content server, the relay server 2 allows both participants in the transfer to exchange a security key beforehand (see FIG. 5). This is then used by the recipient to identify itself when connected directly peer-to-peer, validating its authority to download the requested information.

Since data traveling over the Internet 12 can potentially be captured and misused, an additional encryption layer (not shown) may be added to prevent individual network packets from being readable to an intercepting party. Many existing mechanisms already exist for this purpose. The most common of these is the Secure Sockets Layer (SSL), a mature technology originally created by Netscape for use with web browsers. Since the present invention relies in part on HTTP to transfer information, SSL is a suitable and complementary technology.

In addition to coordinating information search and retrieval, the messaging protocol of the invention allows an application to send and receive instant messages, maintain contact lists, and keep track of online contacts via its connection to a relay server. Instant messages need not be limited to plain text. Instead, the invention provides integrated support allowing richer content to be easily sent to another user as an intuitive link in an instant message, which can then be downloaded via a peer-to-peer connection at the recipient's discretion. Although most existing IM clients support similar types of functionality, they are generally limited to transfer of files, whereas the present invention can transfer anything that Enfish Onespace has access to, including contacts, emails, and web bookmarks.

Because of the ability to route non-textual (e.g. binary) messages between specific users, new message types can easily be created to extend functionality as need arises in the future. The popularity of the Internet as an entertainment medium suggests that one such application might involve creating an interactive multi-player card game or board game.

To help route queries for information as efficiently as possible to the most appropriate machines on the network, the invention relies on the concept of group membership. In order for any content server to share information on the network, or for any search client to query those servers, each must create or join one or more groups hosted by the relay server. This can be thought of analogously as each machine “listening in” to one or more “party lines”, which may or may not require a password for membership. By participating in a group, a user may establish restrictions on the content to share with other members of that group. Each machine may have different and independent restrictions for each group. When somebody then queries a group for a particular piece of information, each participant has the ability to refine the broader group-targeted query with its own filters before it processes the query, effectively limiting the scope of what it returns in response.

A user can create custom groups to suit his or her needs. In addition to specifying an optional password, the group's creator may provide a topic or short description, and choose whether or not to allow the relay server to publish the group so other users may easily find and join it. After creating a group, a user can then export and e-mail a file containing the settings necessary for another machine to effortlessly add the group to its subscription list. The other machines subscribing to the group may belong to friends and colleagues, or alternatively to the only creator of the group if he or she desires it for personal use solely.

Because groups can be created topically with descriptions of their intended use, a user can choose to participate in a set of groups based on his or her informational needs. Information found in these groups has a higher probability of being relevant. This is largely due to the fact that human eyes are more likely to have reviewed the content before sharing it, and to have only shared it with the appropriate groups.

For example, a user with interests in fine dining, wine collecting, travel, and bicycling could join four appropriate groups, each whose stated purpose is the sharing of information about these respective topics or common interests. A copy of the corner bistro's current wine list could be shared with both the “Fine Dining” and “Wine Enthusiast” groups; a buyer's guide from bicycle manufacturer Trek would best be shared with only the “Cycling” group; while a link to a web site advertising a vacation featuring a week-long culinary tour of Napa Valley via bicycle might be suitable for all four. In each case, the act of sharing the item does not mean it will appear in all queries to a particular group, merely that as long as it meets the criteria of another user's search, it may be returned for that search. This human refinement of selectively sharing content is what distinguishes Antenna, preventing a search of the “Cycling” group for the word “trek” from returning information about a science fiction television show, as would happen with a web search engine.

Unlike other peer-to-peer information sharing architectures, the invention does not require all participants in a group to synchronize every piece of collectively shared information. This is because the invention enables a group participant to selectively choose which pieces of information to download and view, conserving valuable (and potentially costly) network bandwidth and system resources. When any information is downloaded or viewed from a remote machine, the copy of the information can be potentially re-shared. This replication and redundancy helps ensure that the most popular information in a group is available to other group members, even when the machine that initially hosted the content is no longer online, thus helping to minimize “information bottlenecks”.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A system for retrieving remote data based on its content, comprising:
a plurality of content servers, each content server having a database which stores data and a corresponding searchable real-time index of the data stored in the database;
a search client;
a relay server connected to the plurality of content servers and the search client, the relay server receiving a query for data from the search client and reflecting the query to the plurality of content servers, wherein
each of the plurality of content servers search their respective indices for data corresponding to the query and, if data corresponding to the query is stored in the respective database, a message is sent through the relay server to the search client.

2. The system of claim 1, wherein data corresponding to the query is transferred directly between the content servers and the search client.

3. The system of claim 1, wherein data corresponding to the query is transferred directly between the content servers and the search client using hypertext transfer protocol.

4. The system of claim 1, wherein data corresponding to the query is transferred from the remote servers to the search client through a mutually acceptable proxy server.

5. The system of claim 1, wherein the search clients is a previously authenticated end user.

6. The system of claim 1, wherein a plurality of relay servers can be interconnected via the internet.

7. The system of claim 1, wherein the relay server enables the content servers and the search client to exchange a security key before the data corresponding to the query is transferred between the content servers and the search client and the security key is authenticated prior to the transfer of the data.

8. The system of claim 1, wherein an instant message can be transferred between the content servers and the search client through the relay server.

9. The system of claim 8, wherein the instant message contains a link which can be downloaded from by a recipient of the instant message through a peer to peer connection between the content servers and the search client.

10. The system of claim 8, wherein the instant message can contain at least one of a contact, an email and a web bookmark.

11. The system of claim 1, wherein the relay server hosts a group and the content servers and search client must each join the group hosted by the relay server to share data with other members in the group.

12. The system of claim 1, wherein a frequency of access of the indexed data is tracked for each content server and data which is accessed a predetermined number of times is automatically transferred to the other content servers.

13. A method for retrieving remote data based on its content, comprising:
transmitting a query for data from a search client to a relay server which is connected to a plurality of content servers;
reflecting the query for data to the plurality of content servers;
searching a real-time index of data stored in a database in each of the plurality of content servers for data corresponding to the transmitted query;
transmitting a message through the relay server to the search client.

14. The method of claim 13, further comprising transferring the data corresponding to the query directly from the content server storing the data to the search client.

15. The method of claim 14, wherein the data is transmitted from the content server storing the data to the search client through a mutually acceptable proxy server.

16. The method of claim 14, wherein the data is transferred using hypertext transfer protocol.

17. The method of claim 13, wherein the relay server enables the content servers and the search client to exchange a security key before the data is transferred between the content servers and the search client and the security key is authenticated prior to the transfer of the data.

18. The method of claim 13, wherein an instant message can be transferred between the content servers and the search client through the relay server.

19. The method of claim 18, wherein the instant message contains a link which can be downloaded from by a recipient of the instant message through a peer to peer connection between the content servers and the search client.

20. The method of claim 18, wherein the instant message can contain at least one of a contact, an email and a web bookmark.

21. The method of claim 13, wherein the relay server hosts a group and the content servers and the search client must each join the group hosted by the relay server to share data with other members in the group.

22. The method of claim 13, wherein a frequency of access for indexed data is tracked for each content server and data which is accessed a predetermined number of times is automatically transferred to the other content servers.
